(19) United States
(12) Patent Application Publication
(10) Pub. No.: US 2016/0140009 A1
(43) Pub. Date: May 19, 2016

(54) SPECIFYING METHOD AND SPECIFYING APPARATUS

(71) Applicant: FUJITSU LIMITED, Kawasaki-shi (JP)

(72) Inventors: Yukihiro Watanabe, Kawasaki (JP); Yasuhide Matsumoto, Kawasaki (JP); Shinya Kitajima, Shinagawa (JP)

(73) Assignee: Fujitsu Limited, Kawasaki-shi (JP)

(21) Appl. No.: 14/864,140

(22) Filed: Sep. 24, 2015

(30) Foreign Application Priority Data
Nov. 17, 2014 (JP) 2014-232493

(51) Int. Cl. G06F 11/30; G06F 11/34

(52) U.S. Cl. CPC G06F 11/3058; G06F 11/3003; G06F 11/3495

(57) ABSTRACT

A specifying method executed by a computer, the specifying method includes: acquiring, every specific time interval, a measurement value of a specific property from each of a plurality of devices which have the specific property; calculating a variation between the measurement value for each of the plurality of devices and an estimated value based on a plurality of past measurement values which are acquired from the plurality of devices prior to the measurement value; and specifying at least one device, which expresses a different behavior from other devices, from among the plurality of devices based on a set of variations including the variation regarding the plurality of devices.

### CROSS-REFERENCE TO RELATED APPLICATION

This application is based upon and claims the benefit of priority of the prior Japanese Patent Application No. 2014-232493, filed on Nov. 17, 2014, the entire contents of which are incorporated herein by reference.

### FIELD

The embodiments discussed herein are related to a technology for specifying an abnormal device.

### BACKGROUND

An operation is monitored in order to detect the abnormality of a device. When the operation is monitored, information relevant to performance is periodically acquired from the device through the Internet or the like. Further, the acquired information is determined based on monitoring rules, and thus the abnormality of the device is detected. The information relevant to performance includes, for example, a measurement value such as temperature, humidity, or voltage.

The related arts are disclosed in, for example, Japanese Laid-open Patent Publication No. 10-310329, Japanese Laid-open Patent Publication No. 2013-218550, Japanese Laid-open Patent Publication No. 2006-107179, and Japanese Laid-open Patent Publication No. 2004-309998.

The monitoring rules are, for example, rules which prescribe whether or not the measurement value belongs to a predetermined range. When the operation is monitored and the measurement value violates the monitoring rules, a notification of the occurrence of an abnormality is provided to the person in charge.

However, there is a case in which the monitoring rules are made without taking into consideration another piece of information (for example, outside air temperature or the like) which affects the measurement value. Accordingly, when another piece of information varies, there is a case in which it is difficult to appropriately determine the abnormality of the device. In addition, when a variation occurs which affects the measurement value, such as a variation in a system configuration, the monitoring rules have to be changed.

In addition, as an abnormality detection method which does not use the monitoring rules, there is a method of detecting the abnormality of a device by learning the normal behaviors of the device and detecting behaviors which are different from the normal behavior. An abnormality detection method, in which monitoring rules are not used, is disclosed in, for example, Japanese Laid-open Patent Publication No. 10-310329.

### SUMMARY

According to an aspect of the invention, a specifying method executed by a computer, the specifying method includes: acquiring, every specific time interval, a measurement value of a specific property from each of a plurality of devices which have the specific property; calculating a variation between the measurement value for each of the plurality of devices and an estimated value based on a plurality of past measurement values which are acquired from the plurality of devices prior to the measurement value; and specifying at least one device, which expresses a different behavior from other devices, from among the plurality of devices based on a set of variations including the variation regarding the plurality of devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an operation monitoring system according to an embodiment;

FIG. 2 is a graph illustrating detection of the abnormality of a device;

FIG. 3 is a diagram illustrating items indicative of pieces of information of the device according to the embodiment;

FIG. 4 is a diagram illustrating the hardware configuration of an abnormal device specifying apparatus illustrated in FIG. 1 according to a first embodiment;

FIG. 5 is a diagram illustrating an example of a device list table illustrated in FIG. 4;

FIG. 6 is a diagram illustrating a software block diagram of the abnormal device specifying apparatus illustrated in FIG. 4;

FIG. 7 is a diagram illustrating an example of a measurement value table illustrated in FIG. 4;

FIG. 8 is a diagram illustrating the outline of a variation calculating process performed by a variation calculation module illustrated in FIG. 6;

FIG. 9 is a diagram illustrating an example of a variation table illustrated in FIG. 4;

FIG. 10 is a diagram illustrating the outlines of processes performed by a divergence score calculation module and an abnormality determination module illustrated in FIG. 6;

FIG. 11 is a diagram illustrating an example of a divergence score table illustrated in FIG. 4;

FIG. 12 is a diagram illustrating an example of an abnormal device table illustrated in FIG. 4;

FIG. 13 is a flowchart illustrating a process performed by the variation calculation module illustrated in FIG. 6;

FIG. 14 is a flowchart illustrating a process performed by the divergence score calculation module illustrated in FIG. 6;

FIG. 15 is a flowchart illustrating a process performed by the abnormality determination module illustrated in FIG. 6; and

FIG. 16 is a graph illustrating a Mahalanobis distance based on the correlation between the measurement value of a device and the variation in the measurement value.

### DESCRIPTION OF EMBODIMENTS

It is preferable that the abnormality of a device is detected in an abnormality sign step before the abnormality appears in a measurement value. However, even when an abnormality detection method in which monitoring rules are not used, it is not easy to detect the abnormality of the device in an abnormality sign step.

According to an aspect, an object of a technology disclosed in the embodiment is to specify a device which has an abnormality sign without the monitoring rules.

Hereinafter, embodiments will be described with reference to the accompanying drawings. However, the technical ranges of the embodiments are not limited to the embodiments and include items described in the claims and the equivalents thereof.

### Operation Monitoring System

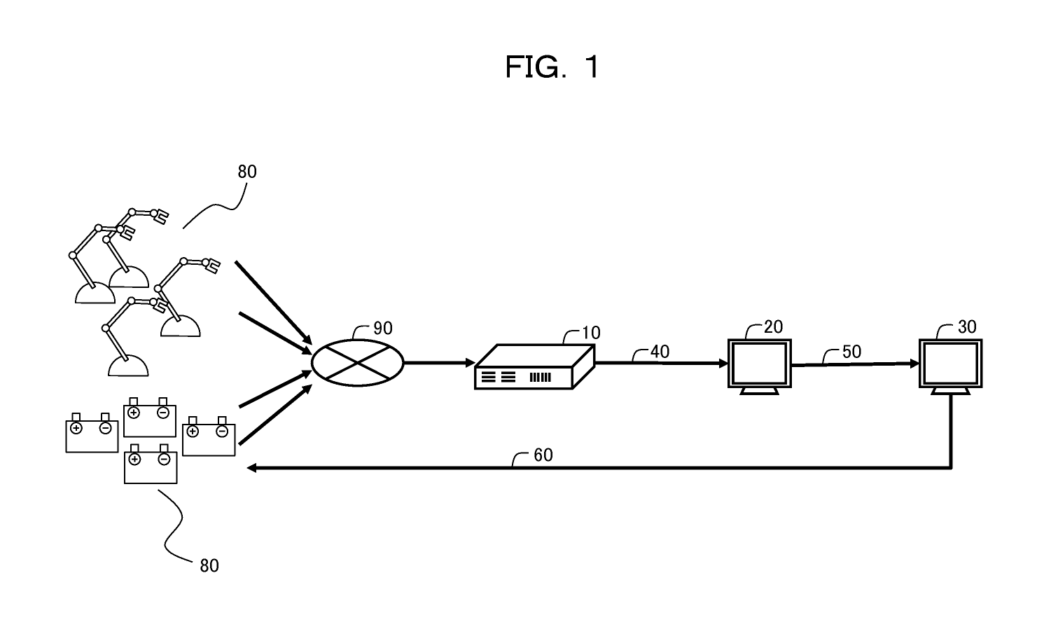

FIG. 1 is a diagram illustrating an operation monitoring system according to an embodiment. The operation monitoring system illustrated in FIG. 1 is a system which manages the operations of devices 80 based on monitoring the behaviors of the devices. In addition, the operation monitoring system illustrated in FIG. 1 is a monitoring system based on the Internet of things (IoT) or the Internet of everything (IoE). The operation monitoring system illustrated in FIG. 1 acquires the states of various devices in addition to an information processing device, such as a computer, through the Internet 90. Further, the operation monitoring system monitors the existence or non-existence of an abnormality of each of the devices 80 based on the acquired information.

The operation monitoring system illustrated in FIG. 1 includes monitoring target devices 80, an abnormal device specifying apparatus 10, a monitoring device 20, and a client device 30. The monitoring device 20 is, for example, the information processing device of a monitoring operator. The client device 30 is, for example, the device of the person in charge of the devices 80, and includes a personal computer, a mobile terminal, or the like.

The abnormal device specifying apparatus 10 detects an abnormality of the monitoring target device 80. More specifically, the abnormal device specifying apparatus 10 periodically collects the operation data of a previously designated device 80 through the Internet 90. The operation data includes, for example, information relevant to the performance of the device 80, and a measurement value acquired by measuring the state of the device 80. The abnormal device specifying apparatus 10 detects an abnormality of the device 80 based on the measurement value of the device 80, and notifies the monitoring device 20 of the information of the device 80 which is determined to be abnormal (40 in the drawing).

The monitoring device 20 transmits the information of the device 80, in which the abnormality is detected, to the client device 30 of the person in charge of the device 80 in response to the notification of the information of the device 80 in which the abnormality is detected (50 in the drawing). The person in charge processes the device 80 based on the notification (60 in the drawing). For example, the person in charge visits a place at which the monitoring target device 80 is installed, and exchanges or repairs the device 80.

In the embodiment, the device 80, which is the monitoring target of the operation monitoring system, includes, for example, a storage battery which is provided in a building or a machine which is provided in a factory. The storage battery is a storage battery which is provided, for example, for preparation against instantaneous service interruption or power consumption peak control of the building. In addition, the machine which is provided in the factory includes, for example, a manufacturing machine for manufacturing a predetermined product. When the monitoring target device 80 is the storage battery, the measurement value includes, for example, temperature, voltage, and the like. In addition, when the monitoring target device 80 is the manufacturing machine, the measurement value includes, for example, moisture, frequency, and the like.

Meanwhile, the examples of the devices 80 and the measurement values are not limited to the above-described examples. The device 80 may be a components which is included in the storage battery, the manufacturing machine, the information processing device, or the like. That is, the device 80 may be a hard disk drive (HDD), a sensor, or the like. In addition, the device 80 is not limited to a device 80 for an enterprise, and may include a device 80 for household use.

When an abnormality occurs in the storage battery, the manufacturing machine or the like, there is a case in which trouble occurs in business. For example, when an abnormality occurs in the storage battery, there is a case in which it is difficult to charge the predetermined amount of electric charge, and thus it is difficult to lower the peak power to a predetermined value. In addition, for example, when an abnormality occurs in the manufacturing machine, there is a case in which a defective product is mixed in with products manufactured by the manufacturing machine. Therefore, in the operation monitoring system, it is desired to detect in advance an abnormality of the device 80 which is the monitoring target.

### Abnormality Detection

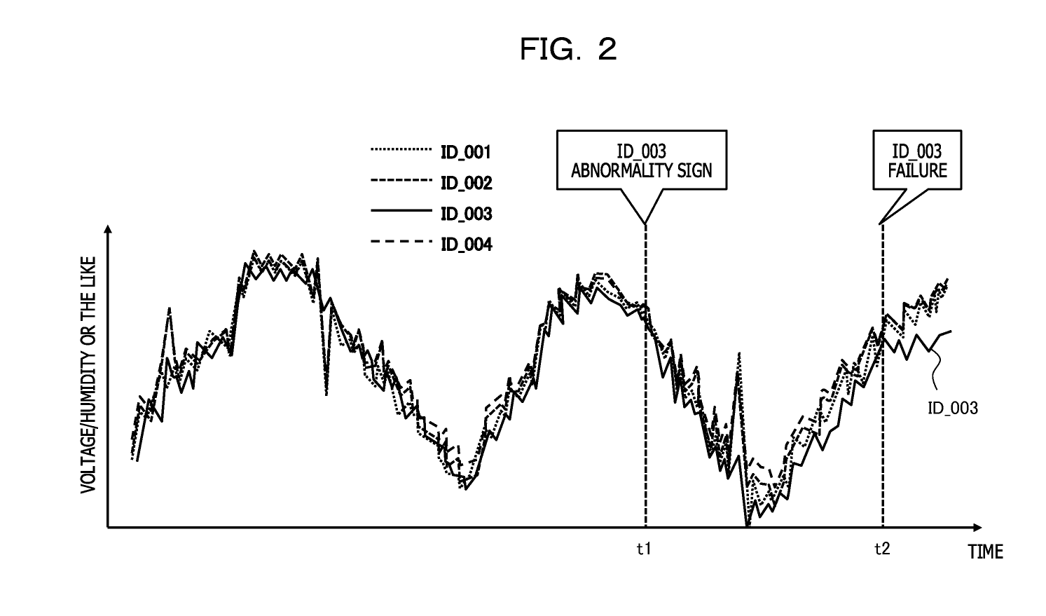

FIG. 2 is a graph illustrating the detection of the abnormalities of the devices 80. The graph illustrated in FIG. 2 expresses transitions of measurement values corresponding to four devices 80 ID_001 to ID_004 according to time.

In the graph illustrated in FIG. 2, a horizontal axis indicates time and a vertical axis indicates a measurement value. The measurement value includes, for example, voltage or temperature which is measured in the devices 80. In addition, a dotted line in the graph indicates a measurement value corresponding to the device ID_001, and a broken line indicates a measurement value corresponding to the device ID_002. In addition, the solid line in the graph indicates a measurement value corresponding to the device ID_003, and a dashed line indicates a measurement value corresponding to the device ID_004.

The graph of FIG. 2 illustrates a case in which an abnormality occurs in the device ID_003. When the abnormality of the device 80 is detected, for example, a device 80, in which a measurement value deviates from a predetermined threshold range, is detected as a device 80 in which an abnormality occurs. In order to suppress occurrence of the incorrect determination of the abnormality of a device 80, for example, the threshold range is set to a range of measurement values which indicate clear abnormalities.

Time t2 in the graph indicates time that the measurement value deviates from the threshold range. That is, time t2 indicates time that the measurement value of the device 80 expresses a clear abnormality. At time t2, the measurement value corresponding to the device ID_003 deviates from the threshold range, and thus it is known that the failure of the device ID_003 is detected. In addition, time t1 in the graph indicates time that an abnormality sign of the device 80 is generated. During a period from time t1 to time t2, there is an abnormality sign of the device ID_003 but the measurement value is not deviated from the threshold range. Accordingly, the abnormality of the device ID_003 is not detected during the period from time t1 to time t2.

A case in which the measurement value corresponding to the device 80 deviates from the threshold range indicates a case in which the measurement value indicates a clear abnormality and the failure of the device 80 is actualized. After the failure is actualized, the range of influence is large. Accordingly, it is desired to detect the abnormality sign of the device 80 at the point in time (time t1) that the abnormality sign appears in the device ID_003 before the point of time (time t2) that the measurement value indicates a clear abnormality. However, it is not easy to set the threshold range in which the abnormality sign is detected. In addition, there is a case in which an abnormality is determined or normality is determined with regard to the same measurement value according to a situation.

For example, a case in which a measurement value indicates the temperature of a sensor of a device 80 will be described as an example. For example, when the rate of operation of the device 80 is high during a day, a temperature of 60° C. corresponds to a normal value. In contrast, when the rate of operation of the device 80 is low during a holiday, a temperature of 60° C. corresponds to an abnormal value. In addition, there is a case in which the threshold values change daily or weekly. Accordingly, it is not easy to set an appropriate threshold value to detect the abnormality sign.

Here, an abnormality detection method using anomaly detection, in which the threshold value does not have to be set, is known. In the anomaly detection, individually preparation of monitoring rules is not demanded. In the anomaly detection, the normal behavior of the monitoring target device 80 is learned and behaviors which are different from the normal behavior are detected, thereby detecting the abnormality of the device 80.

However, when the change in the configuration of the device 80 occurs, the device 80 is determined to be abnormal after the configuration of the device 80 is changed. That is, it is difficult to use the learned normal behavior. In addition, it is difficult to prepare the normal behavior with regard to the device 80 (storage battery or the like) in which the behavior significantly changes due to outside air temperature, load, or the like. Accordingly, it is preferable to use a technology in which it is not demanded to learn the normal behavior.

In addition, according to the anomaly detection, the normal behavior is learned, and thus normal data is desired for a prescribed period. When the operations of a multitude of devices 80 are monitored, there are many cases in which failure occurs in any of the devices 80 among the multitude of devices 80. Accordingly, when the operations of a multitude of devices 80 are monitored, it is not easy to prepare normal data.

Accordingly, in the embodiment, measurement values of devices 80 are acquired for each of the respective ones of the plurality of devices 80 in which a predetermined item indicative of the information of the device 80 is identical. Further, in the embodiment, variations which indicate the differences between the acquired measurement values and estimated values of the measurement values based on the past measurement values of the devices 80 are calculated for each of the respective ones of plurality of devices 80, and a device 80, which has a variation that is different from those of other devices 80, is specified from among the plurality of devices 80.

In the embodiment, the variations, which indicate differences between the estimated values of the measurement values and actual measurement values, are calculated, and the device 80, which has the abnormality sign, is detected based on the difference in the variations between the plurality of devices 80 in which the predetermined item is identical. That is, in the embodiment, the variations in the behaviors of the devices 80 are digitized based on the degrees (the variations) of the variations in the measurement values based on the estimated values. Therefore, it is possible to compare the variation in the behaviors. Accordingly, when the measurement value does not indicate a clear abnormality, it is possible to detect an abnormality sign.

In addition, in the embodiment, the variations are compared between each of the respective ones of the plurality of devices 80 in which an identical predetermined item indicative of the information of the device 80 is identical. Therefore, it is possible to specify the device 80 which has the abnormality sign without maintaining monitoring rules. In addition, when the variation at certain time is compared between the plurality of devices 80, the normal behavior of the device 80 does not have to be learned.

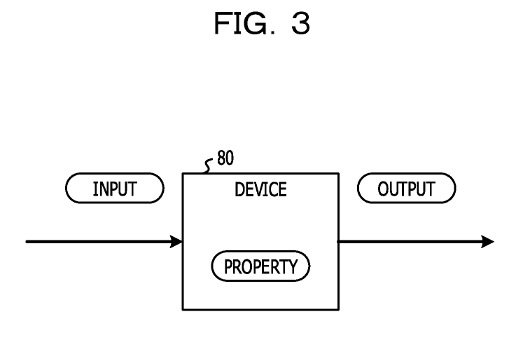

FIG. 3 is a diagram illustrating items indicative of pieces of information of the device 80 according to the embodiment. The items according to the embodiment include an item (properties illustrated in FIG. 3) which is relevant to the properties of the configuration of the device 80, and an item (input illustrated in FIG. 3) which is relevant to input to the device 80 other than the configuration of the device 80.

The item which is relevant to the properties of the configuration of the device 80 corresponds to properties illustrated in FIG. 3. For example, when the device 80 is the storage battery, the item which is relevant to the properties of the device 80 indicates the model of the device 80, the model of an included component, a configuration specification (chargeable electric charge amount), or the like. In addition, the item which is relevant to the input to the device 80 corresponds to input illustrated in FIG. 3. For example, when the device 80 is the storage battery, the item which is relevant to the input to the device 80 indicates the installation place (installation condition) of the storage battery, an outside temperature, charging and discharging cycle, or the like.

The device 80 has an output according to the item which is relevant to the input based on the item which is relevant to the properties. The output of the device 80 is, for example, the measurement value of the device 80. For example, when the device 80 is the storage battery, the output of the device 80 is the measurement value of a temperature, a voltage or the like. That is, the measurement value of the device 80 is determined according to the item which is relevant to the properties of the device 80 or the item which is relevant to the input. For example, when the device 80 is the storage battery, the measurement value (output) of a voltage has a value according to the model of the storage battery (item which is relevant to the properties) or the installation place (item which is relevant to the input).

In addition, in the embodiment, the abnormality sign of the device 80 is, for example, the change in the properties of the device 80. When the device 80 is the storage battery, the change in the properties of the device 80 is, for example, the change (deterioration) in the chargeable electric charge amount of the storage battery.

In the embodiment, a view is taken that the same output (measurement value) is expressed as a behavior in the plurality of devices 80 in which a predetermined item is identical. That is, in the embodiment, when the way of change (the variation) of the outputs (measurement values) are compared between the plurality of devices 80 in which the identical predetermined item is identical, the device 80 in which the properties are changed is specified. In other words, when the variation acquired by digitizing the changes in behavior is compared between a plurality of devices 80 which have equivalent behaviors in a normal case, the device 80 in which the properties are changed is specified.

Therefore, it is possible to specify the device 80 in which the properties are changed, that is, the device 80 which has the abnormality sign. Meanwhile, as described above, the variation at a certain time is compared between the plurality of devices 80 which have equivalent behaviors in a normal case, and thus the monitoring rules are not maintained and the normal behavior of the device 80 does not have to be learned.

### First Embodiment

Subsequently, the hardware configuration of the abnormal device specifying apparatus 10 according to a first embodiment and a software block diagram will be described.

### Hardware Configuration Diagram of Abnormal Device Specifying Apparatus

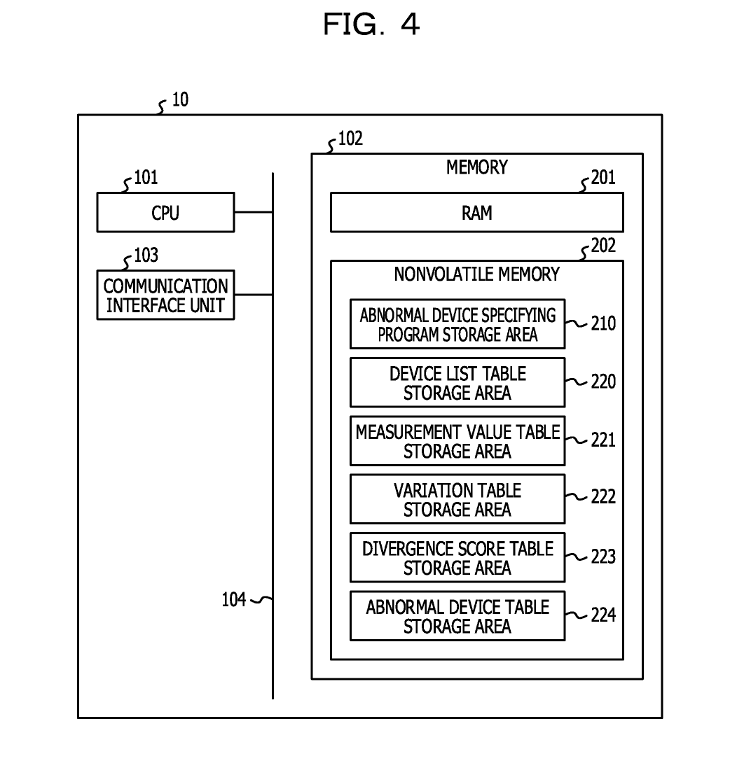

FIG. 4 is a diagram illustrating the hardware configuration of the abnormal device specifying apparatus 10 illustrated in FIG. 1 according to a first embodiment. The abnormal device specifying apparatus 10 illustrated in FIG. 1 includes, for example, a central processing unit (CPU) 101, a memory 102 having a random access memory (RAM) 201 or a nonvolatile memory 202, and a communication interface unit 103. The respective units are connected to each other through a bus 104.

The CPU 101 is connected to the memory 102 or the like through the bus 104 and controls the entire abnormal device specifying apparatus 10. The communication interface unit 103 is connected to the Internet 90 or an Intranet. The RAM 201 of the memory 102 stores data, which is processed by the CPU 101, or the like.

The nonvolatile memory 202 of the memory 102 includes an area (not illustrated in the drawing) which stores an OS program executed by the CPU 101, and a storage area 210 which stores an abnormal device specifying program which operates on the OS. In addition, the nonvolatile memory 202 includes a device list table storage area 220, a measurement value table storage area 221, a variation table storage area 222, divergence score table storage area 223, and an abnormal device table storage area 224. The nonvolatile memory 202 includes a hard disk drive (HDD), non-volatile semiconductor memory, and the like.

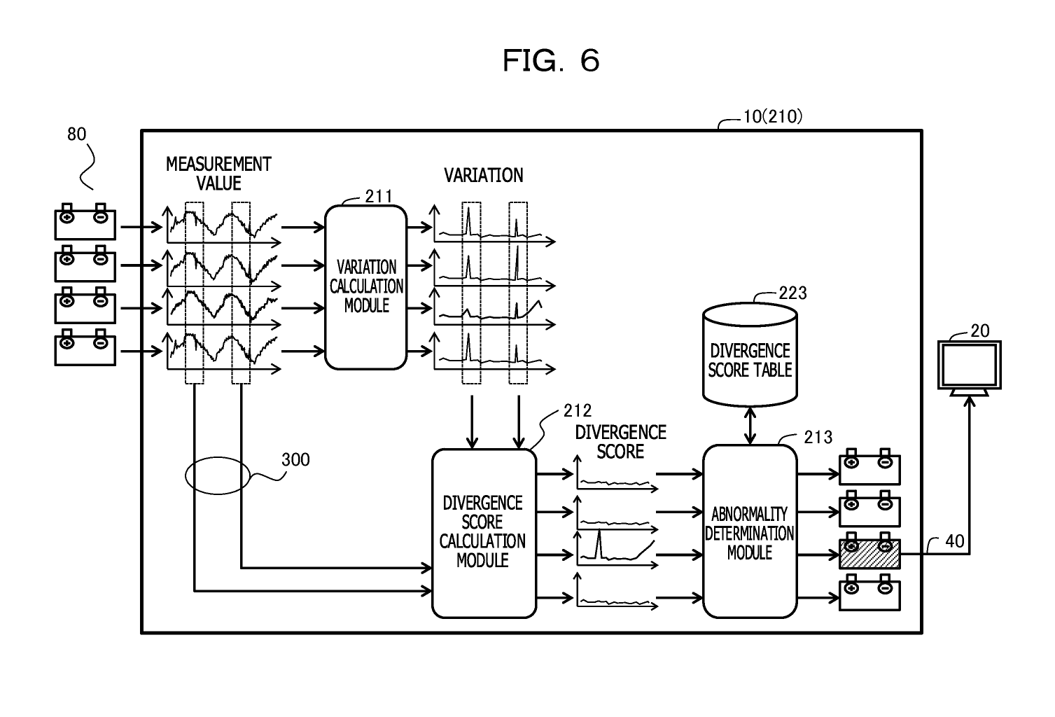

The abnormal device specifying program of the abnormal device specifying program storage area 210 (hereinafter, referred to as an abnormal device specifying program 210) realizes an abnormal device specifying process according to the embodiment when the CPU 101 is executed. The details of the process will be described later with reference to FIG. 6.

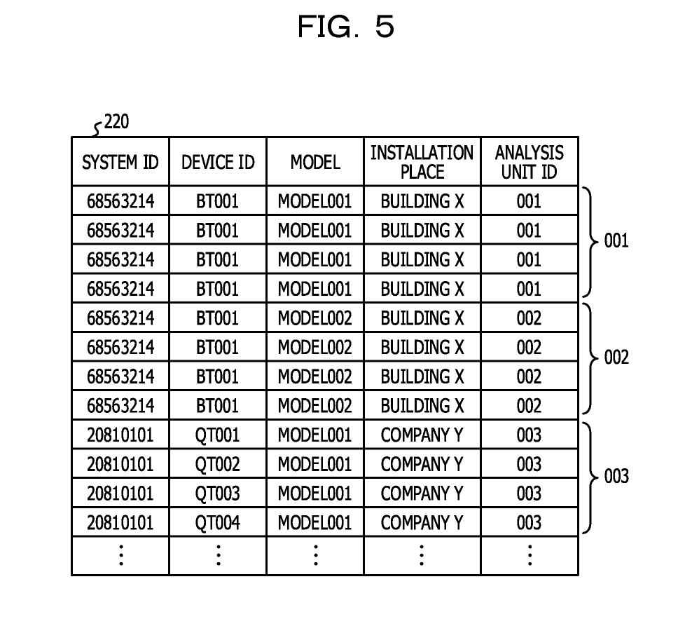

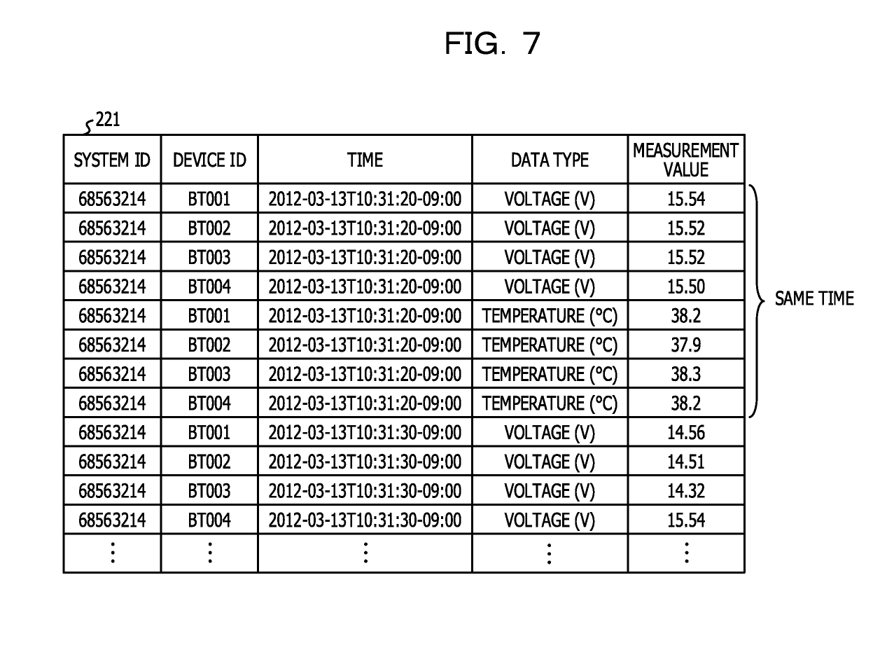

The device list table of the device list table storage area 220 (hereinafter, referred to as a device list table 220) is a table which is referred by the abnormal device specifying program 210. The details of the device list table 220 will be described later with reference to FIG. 5. In addition, the measurement value table of the measurement value table storage area 221 (hereinafter, referred to as measurement value table 221) is a table which is referred by the abnormal device specifying program 210. The details of the measurement value table 221 will be described later with reference to FIG. 7.

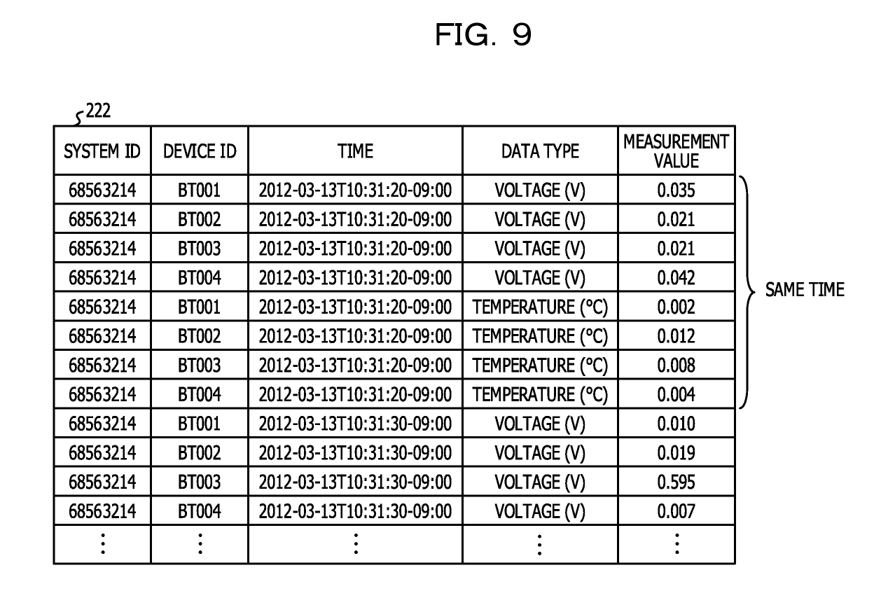

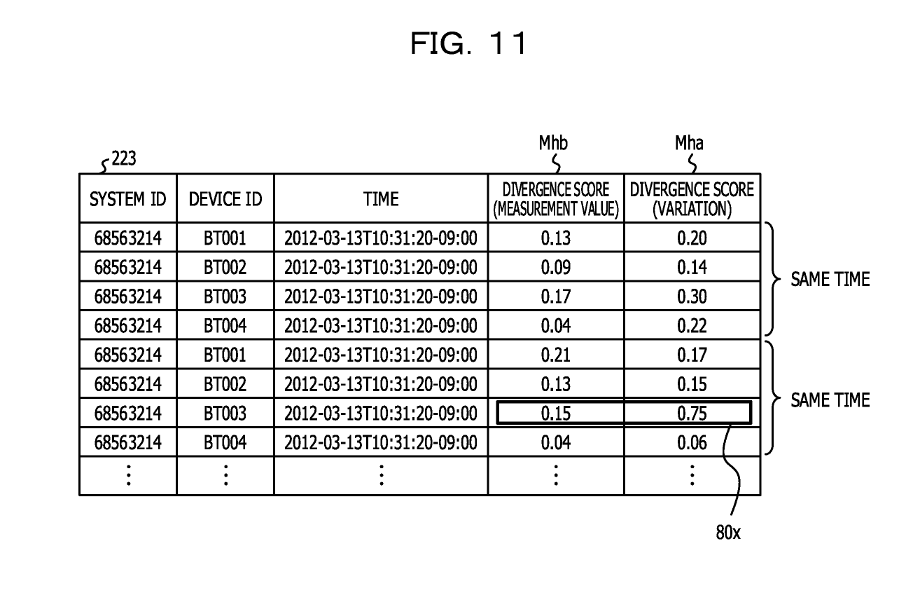

The variation table of the variation table storage area 222 (hereinafter, referred to as a variation table 222) is a table which is updated by the abnormal device specifying program 210. The details of the variation table 222 will be described later with reference to FIG. 9. In addition, the divergence score table of the divergence score table storage area 223 (hereinafter, referred to as a divergence score table 223) is a table which is updated by the abnormal device specifying program 210. The details of the divergence score table 223 will be described later with reference to FIG. 11.

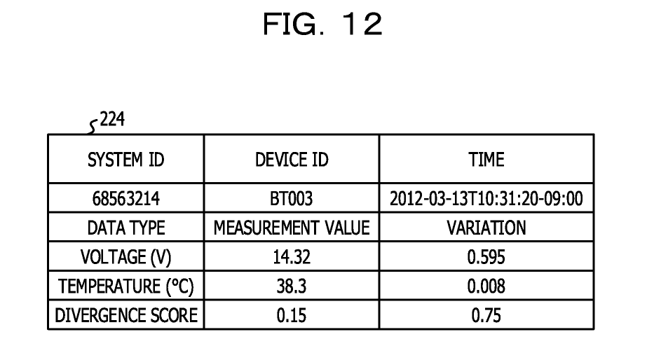

In addition, the abnormal device table of the abnormal device table storage area 224 (hereinafter, referred to as an abnormal device table 224) is a table which is updated by the abnormal device specifying program 210. The details of the abnormal device table 224 will be described later with reference to FIG. 12.

Subsequently, the device list table 220 will be described with reference to FIG. 5. The abnormal device specifying program 210 illustrated in FIG. 4 extracts each of the respective ones of the plurality of devices 80 in which an identical predetermined item indicative of the information of the device 80 is identical from among monitoring target devices 80. Further, the abnormal device specifying program 210 applies the same analysis unit identification (ID), which indicates the same unit for various analyses, to the plurality of extracted devices 80, and stores the analysis unit ID in the device list table 220. In the embodiment, the devices 80 are, for example, storage batteries.

### Device List Table

FIG. 5 is a diagram illustrating an example of the device list table 220 illustrated in FIG. 4. The device list table 220 is a table which includes pieces of information of the respective storage batteries (devices 80) which are the operation monitoring targets. The device list table 220 of FIG. 5 illustrates the pieces of information of some devices of system devices 80 which are the operation monitoring target.

The device list table 220 includes, for example, an item “system ID”, an item “device ID”, an item “model”, an item “installation place”, an item “analysis unit ID”, and the like. The item “system ID” indicates identification information of a system which is the operation monitoring target.

The item “device ID” is the identification information of the device 80. The item “model” is the model information of the device 80. A model includes, for example, the type information of the device 80, the type information of a component, specification information, and the like. In the embodiment, the item “model” corresponds to the item which is relevant to the properties of the device 80 and which is described with reference to FIG. 3. In addition, the item “installation place” is information of a place where the device 80 is installed. The place, where the device 80 is installed, indicates input (outside) factors to the device 80 such as the outside temperature or the like of the device 80. In the embodiment, the item “installation place” corresponds to the item which is relevant to the input to the device 80 and which is described with reference to FIG. 3.

The item “analysis unit ID” is information which identifies the above-described plurality of devices 80 which are set to the same abnormality analysis unit. For example, in the example of FIG. 5, the abnormal device specifying program 210 sets the plurality of devices 80 in which an identical item indicative of the properties of the device 80 (FIG. 3) and an item indicative of the input of the device 80 (FIG. 3) are identical, as the same variation analysis units. More specifically, the abnormal device specifying program 210 sets the plurality of devices 80, in which an identical item “model” (properties) and the item “installation place” (input) are identical, as the same analysis units. Accordingly, in the device list table 220 of FIG. 5, the plurality of devices 80, in which the identical item “model” and the identical item “installation place” are identical, have the same analysis unit ID.

The abnormal device specifying program 210 according to the embodiment extracts a plurality of devices 80, in which one or more identical items (“model”) relevant to the configuration properties of the devices 80 and one or more items (“installation place”) relevant to input to devices 80 excepting for the configuration are identical, as the same analysis units. Therefore, it is possible for the abnormal device specifying program 210 to extract the plurality of devices 80 in which the normal properties are the same and the inputs to the devices 80 are the same. Accordingly, it is possible to specify a device 80 in which the variation is different between the plurality of devices 80 in which the normal behaviors are equivalent

In addition, the abnormal device specifying program 210 may extract a plurality of devices 80 in which one or more identical items from are identical among the plurality of items including the item (“model”) relevant to the properties of the configuration of the device 80 and the item (“installation place”) relevant to the input to the device 80 except for the configuration. For example, the abnormal device specifying program 210 may extract a plurality of devices 80, in which only one item (for example, “model”) relevant to the properties of the configuration is identical, as the same analysis unit. Therefore, it is possible for the abnormal device specifying program 210 to specify a device 80 in which the variation is different among the plurality of devices 80 in which the normal properties are the same. The person in charge of operation monitoring sets the number of items and the kinds of items which are used to extract the plurality of devices 80 as the same analysis unit according to, for example, the types of the devices 80.

According to the example of the device list table 220 illustrated in FIG. 5, systems which are set to the operation monitoring targets include systems which have a system ID “68563214” and a system ID “20810101”. In addition, according to the example of the device list table 220 illustrated in FIG. 5, devices 80 which belong to the system ID “68563214” include device IDs “BT001” to “BT008”, and the installation place thereof is a “building X”.

In the same manner, according to the example of the device list table 220 illustrated in FIG. 5, the device IDs “BT001” to “BT004” have a model “MODEL001”, and the device IDs “BT005” to “BT008” have a model “MODEL002”. In addition, the devices 80 which belong to the system ID “20810101” include device IDs “QT001” to “QT004” and the installation place thereof is a “company Y”. In addition, the device IDs “QT001” to “QT004” have a model “MODEL001”.

Accordingly, the abnormal device specifying program 210 applies the same analysis unit ID “001” to the device IDs “BT001” to “BT004”. In addition, the abnormal device specifying program 210 applies the same analysis unit ID “002” to device IDs “BT005” to “BT008”. Further, the abnormal device specifying program 210 applies the same analysis unit ID “003” to the device IDs “QT001” to “QT004”.

Therefore, the abnormal device specifying program 210 specifies a device 80, in which the variation in the measurement values is different from those of other devices 80 from among the devices with IDs “BT001” to “BT004”, as the device 80 which has the abnormality sign. The same process is performed on the devices 80 which correspond to other analysis unit IDs.

As described above, the abnormal device specifying program 210 according to the embodiment extracts a plurality of devices 80, in which the same unit is used for abnormality detection analysis, based on one or more items indicative of the pieces of information of the devices 80. It is possible to easily extract the item indicative of the information of the device 80 based on the device list table 220 illustrated in FIG. 5, setting information, and the like. Accordingly, when a multitude of devices 80 are set to the monitoring targets, it is possible to easily extract the plurality of devices 80 to which the same analysis unit is set.

Subsequently, a process of comparing the variation in the measurement values between the plurality of devices 80 corresponding to the same analysis unit ID will be described with reference to FIGS. 6 to 12. First, according to FIG. 6, a diagram illustrating the software configuration of abnormal device specifying apparatus 10 according to the embodiment will be described.

### Software Block Diagram

FIG. 6 is a diagram illustrating the software block diagram of the abnormal device specifying apparatus 10 illustrated in FIG. 4. As illustrated in FIG. 6, the abnormal device specifying program 210 includes a variation calculation module 211, a divergence score calculation module 212, and an abnormality determination module 213.

The variation calculation module 211 calculates the variation in the measurement values of the respective devices 80 of the plurality of devices 80 corresponding to the same analysis unit illustrated in FIG. 5. The variation is a value which indicates the difference between the estimated value of the same device 80, which is calculated based on the past measurement value, and an actual measurement value (actual measurement value). That is, the variation is the variation in the actual value for the estimated value based on the past measurement value.

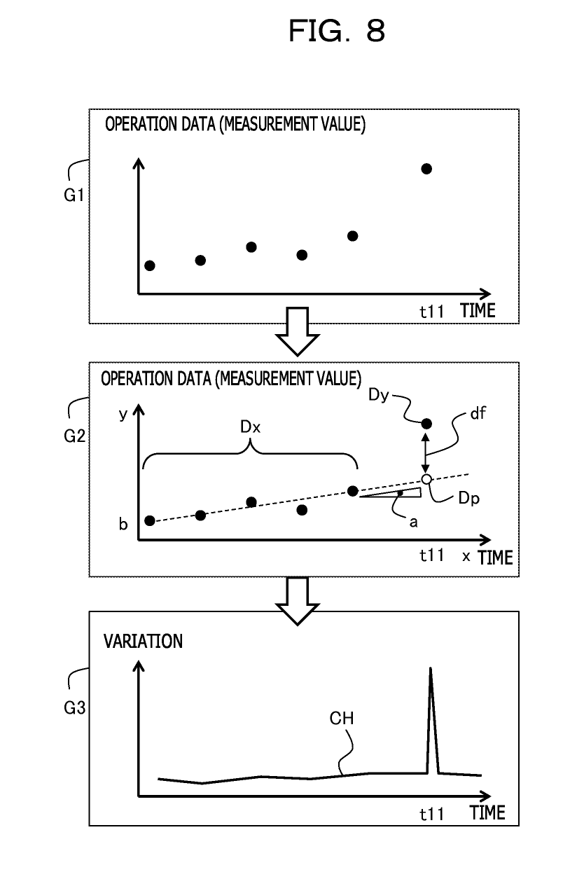

The variation calculation module 211 detects the plurality of devices 80 corresponding to the same analysis unit ID with reference to the device list table 220 illustrated in FIG. 5. In addition, the variation calculation module 211 acquires the measurement values of the respective devices 80 corresponding to the same analysis unit ID with reference to the measurement value table 221 which will be described later with reference to FIG. 7, and calculates the variation in the measurement values. A variation calculating process will be described later with reference to FIG. 8. The variation calculation module 211 stores the calculated variation in the variation table 222 which will be described later with reference to FIG. 9.

The divergence score calculation module 212 calculates variation divergence scores for the respective devices 80 based on the variation which is calculated by variation calculation module 211. The variation divergence score indicates a degree, in which the variation deviates from the variation of other devices 80, between the variation of the plurality of devices 80 corresponding to the same analysis unit ID. That is, the variation divergence score is a score which indicates the divergence degree from the amount of average variation of the plurality of devices 80. It is possible for the divergence score calculation module 212 to detect the devices 80, which has a variation that is different from those of other devices 80, from among the plurality of devices 80 corresponding to the same analysis unit ID by calculating the variation divergence scores.

In addition, the divergence score calculation module 212 calculates the measurement value divergence scores for the respective devices 80 based on the measurement values. The measurement value divergence score indicates a degree in which the measurement value deviates from the measurement values of the other devices 80 between the measurement values of the plurality of devices 80 corresponding to the same analysis unit ID. That is, the measurement value divergence score is a score which indicates a divergence degree from the average measurement value of the plurality of devices 80.

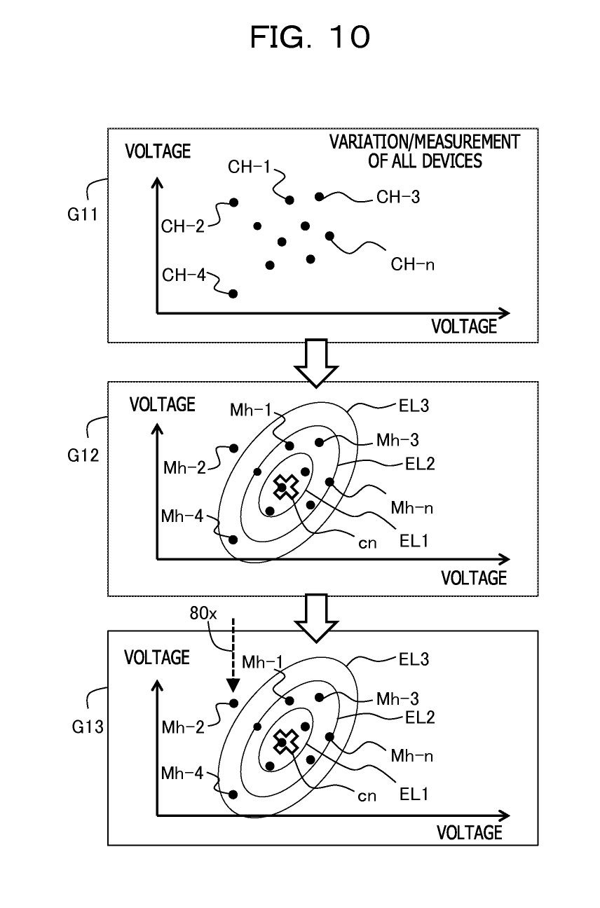

A process of calculating the variation divergence score and the measurement value divergence score will be described later with reference to FIG. 10. The divergence score calculation module 212 stores the calculated variation divergence score and the measurement value divergence score in the divergence score table 223 which will be described later with reference to FIG. 11.

The abnormality determination module 213 specifies the device 80, which has a variation that is different from those of other devices 80, from among the devices 80 corresponding the same analysis unit ID based on the variation divergence scores and the measurement value divergence scores of the respective devices 80, which are calculated by the divergence score calculation module 212. The details of the process will be described later with reference to FIG. 10. The abnormality determination module 213 stores the specified device 80 in the abnormal device table 224 which will be described later with reference to FIG. 12. In addition, abnormality determination module 213 notifies the monitoring device 20 (FIG. 1) of the specified information of the device 80.

Subsequently, the processes of the variation calculation module 211, the divergence score calculation module 212, and the abnormality determination module 213, which are described with reference to FIG. 6, will be described with reference to FIGS. 7 to 12. Meanwhile, in the embodiment, a process performed on the device IDs “BT001 to “BT004” corresponding to the analysis unit ID “001”, which is described with reference to FIG. 5, will be described as an example.

First, the measurement value table 221, which is referred to by the variation calculation module 211, will be described with reference to FIG. 7. The abnormal device specifying apparatus 10 generates the measurement value table 221 illustrated in FIG. 7 by collecting the measurement values of the storage batteries (devices 80) through the Internet 90 or the like.

### Measurement Value Table

FIG. 7 is a diagram illustrating an example of the measurement value table 221 illustrated in FIG. 4. The measurement value table 221 illustrated in FIG. 7 is a table in which the measurement values of the respective operation data are accumulated in in time series. The measurement value table 221 illustrated in FIG. 7 includes the measurement values for the respective operation data of the plurality of devices 80 (for example, the device IDs “BT001” to “BT004”) corresponding to the same analysis unit ID in time series (for every 10 seconds).

The measurement value table 221 illustrated in FIG. 7 includes, for example, an item “system ID”, an item “device ID”, an item “time”, an item “data type”, an item “measurement value” and the like. The item “system ID” and the item “device ID” are as explained in the device list table 220 illustrated in FIG. 5. The item “time” indicates time at which the measurement value is measured. In addition, the item “data type” is the type of operation data. The data type of the operation data in the example illustrated in FIG. 7 includes a “voltage (V)”, and a “temperature (° C.)”.

The abnormal device specifying apparatus 10 collectively acquires, for example, the measurement values of the operating device IDs “BT001” to “BT004”. In addition, the abnormal device specifying apparatus 10 simultaneously acquires the plurality of types of operation data (the voltage and the temperature in the example of FIG. 7).

According to the example of the measurement value table 221 illustrated in FIG. 7, for example, the measurement value of a voltage (V) corresponding to the device ID “BT001”, which belongs to the system ID “68563214”, at time “2012-03-13T10:31:20-09:00” is a value “15.54(V)”. In addition, the measurement value of a voltage (V) corresponding to the device ID “BT002”, which belongs to the system ID “68563214”, at the same time is a value “15.52(V)”. In addition, the measurement value of a temperature (° C.) corresponding to the device ID “BT001” at the same time is a value “38.2(° C.). Further, the measurement value of the voltage (V) corresponding to the device ID “BT001” at a time “2012-03-13T10:31:30-09:00” acquired after 10 seconds is a value “14.56(V)”.

Subsequently, with reference to the measurement value table 221 illustrated in FIG. 7, the outline of a process of calculating the variation in the measurement values, performed by the variation calculation module 211, will be described with reference to FIG. 8.

### Outline of Variation Calculating Process

FIG. 8 is a diagram illustrating the outline of a variation calculating process performed by the variation calculation module 211 illustrated in FIG. 6. The variation calculation module 211 according to the embodiment calculates the variation CH, for example, according to a sequentially discounting AR (SDAR) model learning algorithm.

In an example of FIG. 8 illustrates a case in which the variation CH in the measurement values of certain operation data of a certain device 80 is calculated. FIG. 8 illustrates a case in which the variation CH of a voltage value which is one of the operation data is calculated. The variation calculation module 211 acquires the voltage value (measurement value) of a certain device 80 with reference to the measurement value table 221 illustrated in FIG. 7.

A graph G1 of FIG. 8 is a graph which expresses the measurement values in time series. In the graph G1, a horizontal axis indicates time and a vertical axis indicates the voltage value. In addition, the measurement values illustrated in the graph G1 are, for example, values (that is, actual measurement values) acquired by measuring the voltage values of the certain device 80 for every 10 seconds. According to the graph G1, the measurement values of the voltage values are sequentially raised according to time.

In addition, a graph G2 of FIG. 8 is a graph illustrating an estimated value Dp based on the past measurement values Dx. The value Dp in the graph is a maximum likelihood value at time t11 based on the past measurement values Dx. The maximum likelihood value Dp is the estimated value of the measurement values based on a maximum likelihood method. In addition, a value df of the graph G2 is the difference df between a value (actual measurement value) Dy, which is actually measured at time t11, and the maximum likelihood value Dp.

The variation calculation module 211 calculates the maximum likelihood value Dp according to linear regression analysis based on, for example, a least-squares method. In addition, the variation calculation module 211 may calculate the maximum likelihood value Dp according to weighted linear regression analysis. In the weighted linear regression analysis, the maximum likelihood value Dp is acquired by, for example, calculating a linear model acquired when the weights of the near past measurement values Dx are further increased. Therefore, it is possible to calculate the maximum likelihood value Dp to which the trends of the near past measurement values Dx are significantly applied. Accordingly, it is possible to improve the accuracy of the maximum likelihood value Dp.

Based on the maximum likelihood method, for example, a coefficient “a” and a coefficient “b” of Equation of the linear model “y=ax+b” are acquired. The value “y” indicates the maximum likelihood value Dp and the value “x” indicates time. The respective values in Equation correspond to the respective values illustrated in the graph G2. When time t11 is input as the value “x” in Equation, the maximum likelihood value “y” of time t11 is acquired. Based on the maximum likelihood method, it is possible to calculate an estimated value (maximum likelihood value) in which there is a high possibility which may occur based on the past measurement values Dx even when the measurement values are not uniform and fluctuate. Since it is possible to calculate a highly-accurate estimated value, it is possible to calculate the highly-accurate variation CH.

Graph G3 of FIG. 8 expresses the transition of the variation CH. The variation CH is a value based on the difference df between the maximum likelihood value Dp of the measurement values and the actual measurement value (actual measurement value) Dy. According to the graph G3 of FIG. 8, the variation CH at time t11 is larger than the variation at other times.

In an SDAR algorithm, for example, smoothing is performed on the difference df by stages, and the variation CH is calculated based on the smoothed difference df. That is, in the SDAR algorithm, the variation CH is calculated by accumulating the difference df while attenuating the difference df linearly. Therefore, it is possible to calculate the variation CH from which noise is further removed. However, the embodiment is not limited to the example and the variation calculation module 211 may set the difference df to the variation CH.

It is possible for the variation calculation module 211 to digitize the change in the behaviors of the devices 80 by calculating the variation. That is, it is possible to digitize the change in the behaviors of the devices 80, which is difficult for a person to understand, in accordance with the variation. Therefore, when the measurement value does not indicate a clear abnormality, it is possible to detect the change in the properties of the device 80.

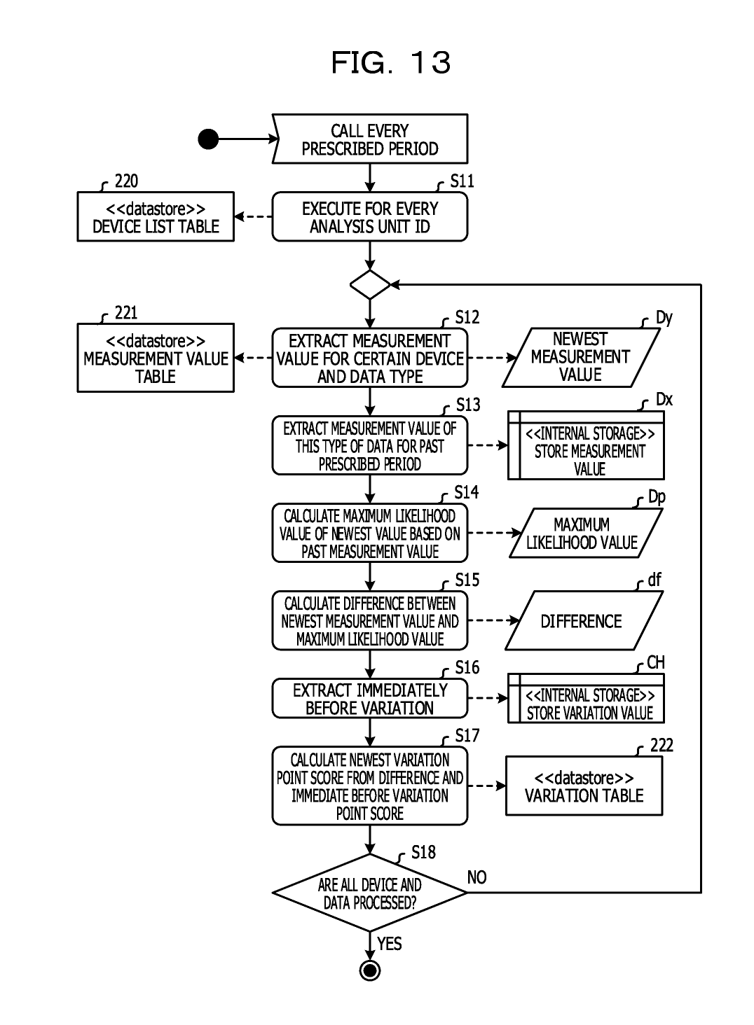

The variation calculation module 211 calculates the variation CH in the measurement values of the respective types for the respective devices 80 according to the calculation process illustrated in FIG. 8. Further, the variation calculation module 211 stores the calculated variation CH in the variation table 222 which will be illustrated in FIG. 9. Meanwhile, the details of the process performed by the variation calculation module 211 will be described later with reference to a flowchart of FIG. 13.

### Variation Table

FIG. 9 is a diagram illustrating an example of the variation table 222 illustrated in FIG. 4. The variation table 222 illustrated in FIG. 9 is a table in which the variation CH in the measurement values at each time is accumulated in time series. The variation table 222 illustrated in FIG. 9 includes the variation CH in the measurement values of the respective operation data corresponding to the device IDs “BT001” to “BT004”.

The variation table 222 illustrated in FIG. 9 includes an item “system ID”, an item “device ID”, an item “time”, an item “data type”, an item “the variation”, and the like. The item “system ID”, the item “device ID”, the item “time”, and the item “data type” are the same as in the description with reference to the measurement value table 221 of FIG. 7. The item “the variation” is the variation CH in the measurement values of the item “data type” of the item “device ID” at the item “time”.

According to an example of the variation table 222 illustrated in FIG. 9, for example, the variation CH in the voltage (V) corresponding to the device ID “BT001” at the time “2012-03-13T10:31:20-09:00” is a value “0.035”. In the same manner, the variation CH in the voltage (V) corresponding to the device ID “BT002” at the same time is a value “0.021”. Accordingly, the difference between the actual measurement value Dy and the maximum likelihood value Dp corresponding to the device ID “BT001” at the time “2012-03-13T10:31:20-09:00” is larger than the difference between the actual measurement value Dy and the maximum likelihood value Dp corresponding to the device ID “BT002”. The other records in the variation table 222 of FIG. 9 include the variation CH in the same manner.

The divergence score calculation module 212 illustrated in FIG. 6 calculates the variation divergence score and the measurement value divergence score with reference to the variation table 222 illustrated in FIG. 9. Further, the abnormality determination module 213 illustrated in FIG. 6 specifies devices 80 which have abnormality signs based on the variation divergence score and the measurement value divergence score. Subsequently, the outline of the processes performed by the divergence score calculation module 212 and the abnormality determination module 213 will be described with reference to FIG. 10.

### Outline of Divergence Score Calculation and Abnormality Determination

FIG. 10 is a diagram illustrating the outline of processes performed by the divergence score calculation module 212 and the abnormality determination module 213 illustrated in FIG. 6. In the embodiment, the divergence score calculation module 212 calculates a Mahalanobis distance for each device 80 as the variation divergence score based on the variation CH. Further, the abnormality determination module 213 determines an abnormality for each device 80 by comparing the Mahalanobis distance of the calculated variation CH (referred to as a variation divergence score) with a predetermined value (threshold value).

When there is correlation between a plurality of items (the temperature and the voltage in the example of FIG. 10), the Mahalanobis distance is an integrated value which is acquired by combining a distance from the average of the targets (the measurement values of the device 80) and the deviation from the correlation. For example, when the Mahalanobis distance of the variation CH of a certain device 80 is small between the plurality of devices 80 corresponding to the same analysis unit ID, it means that the variation CH of the device 80 is positioned in the vicinity of the center of the normal distribution of the variation CH of the plurality of devices 80.

In contrast, when the Mahalanobis distance of the variation CH of a certain device 80 is large between the plurality of devices 80 corresponding to the same analysis unit ID, it means that the variation CH of the device 80 deviates from the center of the normal distribution of the variation CH of the plurality of devices 80. Accordingly, when the Mahalanobis distance of the variation CH of a certain device 80 is larger than a predetermined value, it is possible to determine that the variation CH of the device 80 is different from the variation CH of another device 80.

An example of FIG. 10 illustrates a case in which the Mahalanobis distance (variation divergence score) of the variation is calculated based on the variation CH in the measurement values of the temperature and the voltage. The variation CH illustrated in the example of FIG. 10 is the variation CH at certain time.

A graph G11 of FIG. 10 is a graph acquired by plotting the variation CH in the measurement values of the plurality of operation data (the temperature and the voltage). In the graph G11, a horizontal axis indicates the temperature and a vertical axis indicates the voltage. The graph G11 of FIG. 10 includes the pieces of information of the variation CH-1 to CH-n of the respective devices 80-1 to 80-n corresponding to the same analysis unit ID.

The divergence score calculation module 212 calculates the Mahalanobis distances Mh-1 to Mh-n of the variation CH-1 to CH-n of the respective devices 80 according to the covariance matrix based on the variation CH-1 to CH-n of the temperatures and the voltages of the devices 80-1 to 80-n. That is, the divergence score calculation module 212 calculates the distribution of the correlation of the variation of the temperatures and the voltages between the plurality of devices 80-1 to 80-n as the Mahalanobis distances Mh-1 to Mh-n.

A graph G12 of FIG. 10 is a graph which expresses the Mahalanobis distances Mh-1 to Mh-n of the variation CH-1 to CH-n of the respective devices 80-1 to 80-n. In the graph G12, a horizontal axis indicates the temperature and the vertical axis indicates the voltage. A point cn of the graph G12 is the center (average) of the variation CH-1 to CH-n of the respective devices 80-1 to 80-n. In addition, respective ellipses EL1 to EL3 indicate positions corresponding to a prescribed Mahalanobis distance.

A graph G13 of FIG. 10 is a graph illustrating a device 80 which has the variation CH that is different from those of other devices 80. The abnormality determination module 213 specifies, for example, a device 80, in which the Mahalanobis distances Mh-1 to Mh-n are larger than the Mahalanobis distance in the ellipse EL3, as a device 80 which has the variation CH that is different from those of other devices 80 between the plurality of devices 80-1 to 80-n. That is, the abnormality determination module 213 calculates a reference value which indicates the average of the variation CH of the plurality of devices 80, and specifies devices 80 in which the distance of the variation CH from the reference value is larger than the predetermined threshold value. Therefore, it is possible to specify the device 80 which has the variation CH that is different from those of other devices 80.

According to the graph G13, the Mahalanobis distance Mh-2 corresponding to the variation CH-2 of the device 80-2 is larger than the threshold value illustrated in the ellipse EL3 (80x in the drawing). This means that the difference (the variation CH-2) in the actual measurement value Dy (FIG. 8) for the estimated value Dp (FIG. 8) of the device 80-2 is larger than other devices 80-1 and 80-3 to 80-n. That is, this indicates that the change in the behavior of the device 80-2 is large and the device 80-2 has an abnormality sign.

According to the example of FIG. 10, distribution based on the correlation of the variation CH of the plurality of operation data (the temperature and the voltage) specifies a device, which is different from other devices, as the device 80 which has the abnormality sign. That is, the example of FIG. 10 specifies a device, in which the distribution based on the correlation of a plurality of kinds of the variations CH is different from those of other devices 80, from among the plurality of devices 80.

For example, according to the example of the graph G13 of FIG. 10, the device 80-2 has a large divergence degree from other devices 80 of the variation CH (the vertical axis) in the voltage for the divergence degree of the variation in the temperature (the horizontal axis). As described above, the distribution of the correlation of the variation CH in the temperature and the voltage of the device 80-2 is different from those of other devices 80 of the graph G13. Accordingly, the abnormality determination module 213 specifies the device 80-2 as the device 80 which has the abnormality sign.

As illustrated in FIG. 10, there is a case in which the abnormality sign appears in the distribution of the correlation of a plurality of types of the variation CH according to the device 80. For example, there is a case in which a state, in which the variation CH in the voltage is different from other devices 80 even when the variation CH in the temperature is not different from other devices 80, corresponds to the abnormality sign. In addition, there is a case in which a state, in which the variation CH in the temperature is different from other devices 80 even when the variation CH in the voltage is not different from other devices 80, corresponds to the abnormality sign.

As described above, it is possible to specify the device 80 which has the abnormality sign with higher accuracy by comparing the distribution based on the correlation of the variations CH of the plurality of operation data with those of other devices 80. In addition, it is possible to specify the device 80 which has a finer abnormality sign.

In addition, the example of FIG. 10 illustrates the Mahalanobis distances (variation divergence scores) of the variations CH. However, the divergence score calculation module 212 further calculates the Mahalanobis distances of the measurement values (hereinafter, referred to as measurement value divergence scores). A method of calculating the Mahalanobis distances of the measurement values is the same as the method of calculating the Mahalanobis distances of the variations CH. The divergence score calculation module 212 calculates the Mahalanobis distances of the respective measurement values of the devices 80 according to the covariance matrix based on the measurement values, such as the temperature and the voltage, of the devices 80-1 to 80-n.

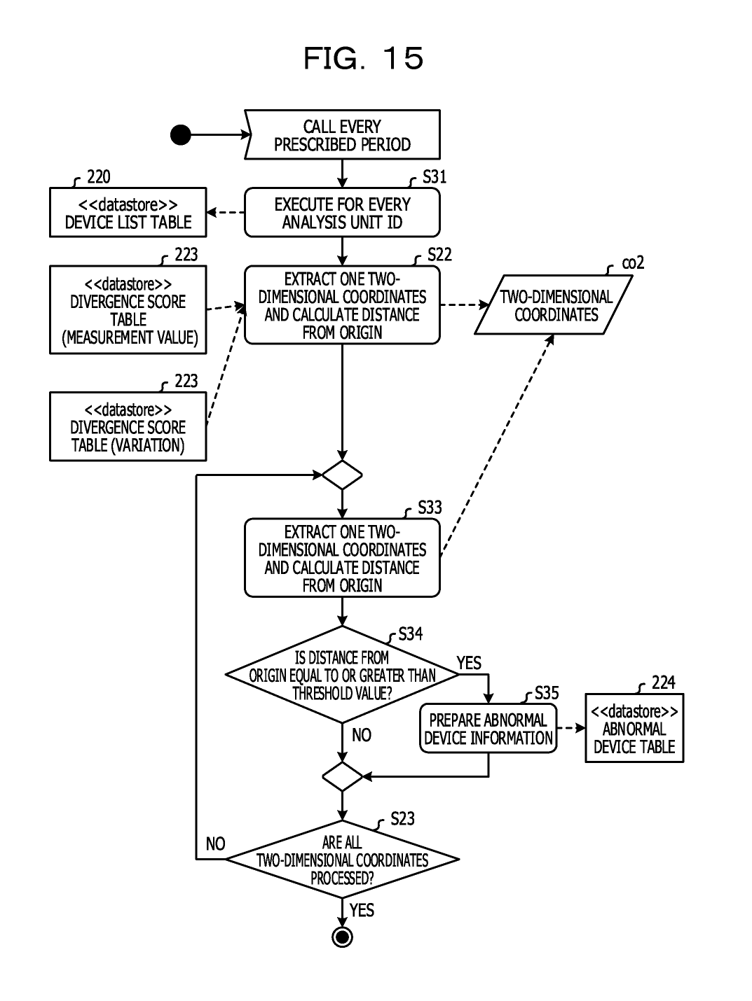

The abnormality determination module 213 specifies a device, which has the variation CH and the measurement value that are different from those of other devices, from among the plurality of devices 80. A process of specifying the device 80 which has the abnormality sign based on the Mahalanobis distance of the measurement value (measurement value divergence score) in addition to the Mahalanobis distance (variation divergence score) of the variation CH will be described later with reference to a flowchart of FIG. 15.

Meanwhile, in the example of FIG. 10, the process of specifying the device 80, in which the variation CH is different, based on the Mahalanobis distance is described based on the correlation of the variations CH in two types of measurement values (the temperature and the voltage). However, the abnormal device specifying program 210 according to the embodiment may specify the device 80 which has the abnormality sign based on the variation CH in one type of measurement value(for example, only the temperature).

In a case based on one type of variation CH, the abnormality determination module 213 specifies, for example, a device 80, in which the variation CH in the temperature deviates from a distribution of the variations CH-1 to CH-n in the temperature, as the device 80 which has the abnormality sign. For example, the abnormality determination module 213 specifies a device 80, in which a deviation value of the variation CH based on the variations CH-1 to CH-n in the temperature is less than the threshold value, as the device 80 which has the abnormality sign. As described above, even in a case in which only one type of operation data is provided, it is possible to specify the abnormality sign based on the variation CH.

In addition, the abnormal device specifying program 210 according to the embodiment may specify the device 80 which has the abnormality sign based on variations CH in three or more types of measurement values. In a case based on three or more types of variations CH, the divergence score calculation module 212 calculates the Mahalanobis distances based on the variations CH in three or more types of measurement values.

For example, when the Mahalanobis distances are calculated based on the variations CH in three or more types of measurement values, the graphs G11 to G13 illustrated in FIG. 10 are graphs of three-dimensional space. The abnormality determination module 213 specifies a device 80, in which a distribution based on the combination of the variations in the three-dimensional space is different from those of other devices, as the device 80 which has the abnormality sign from among the plurality of devices 80.

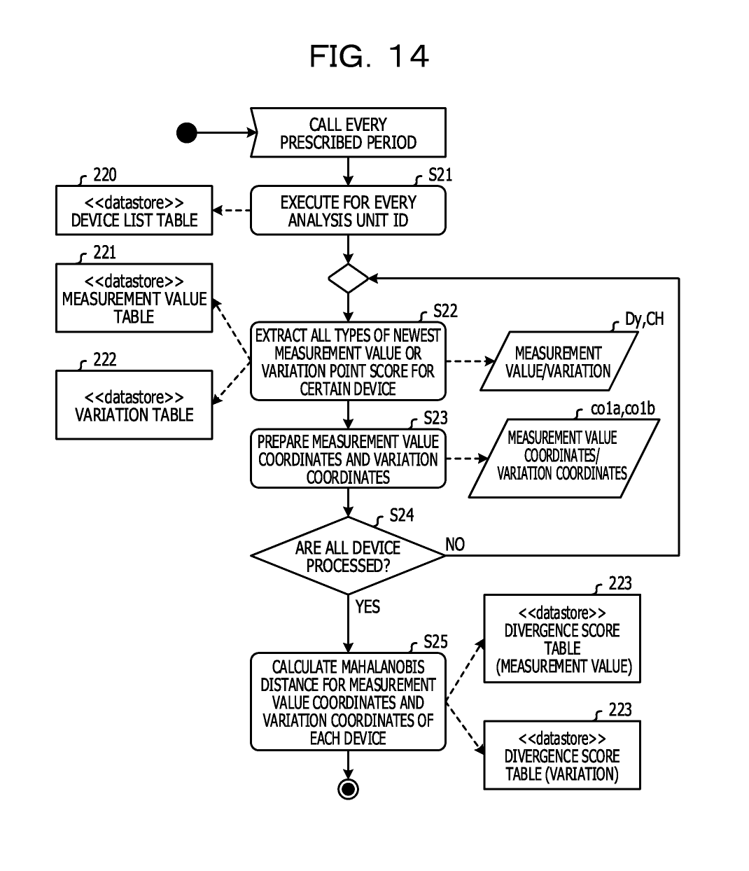

The divergence score calculation module 212 stores the variation divergence score and the measurement value divergence score, in which the outline of the calculation is described with reference to FIG. 10, in the divergence score table 223 which will be described with reference to FIG. 11. The details of the process performed by the divergence score calculation module 212 will be described later with reference to a flowchart in FIG. 14. In addition, the details of the process performed by the abnormality determination module 213 will be described later with reference to a flowchart in FIG. 15.

### Divergence Score Table

FIG. 11 is a diagram illustrating an example of the divergence score table 223 illustrated in FIG. 4. The divergence score table 223 illustrated in FIG. 11 is a table in which the measurement value divergence score (the Mahalanobis distance of the measurement value) Mhb and a variation divergence score (the Mahalanobis distance of the variation) Mha at each time are accumulated in time series.

The divergence score table 223 illustrated in FIG. 11 includes measurement value divergence scores Mhb and the variation divergence scores Mha corresponding to the device IDs “BT001” to “BT004”. The measurement value divergence score Mhb and the variation divergence score Mha are the same as in the description of FIG. 10.

The divergence score table 223 illustrated in FIG. 11 includes an item “system ID”, an item “device ID”, an item “time”, an item “divergence score (measurement value)”, an item “divergence score (the variation)”, and the like. The item “system ID”, the item “device ID”, the item “time”, and the item “data type” are the same as in the description of the measurement value table 221 of FIG. 7. The item “divergence score (measurement value)” is the measurement value divergence score Mhb corresponding to the item “device ID” at the item “time”. In addition, the item “divergence score (the variation)” is the variation divergence score Mha corresponding to the item “device ID” at the item “time”.

According to an example of the divergence score table 223 illustrated in FIG. 11, a measurement value divergence score Mhb corresponding to a device ID “BT001” at time “2012-03-13T10:31:20-09:00” is a value “0.13”. In addition, a variation divergence score Mha corresponding to the same device ID “BT001” at the same time is a value “0.20”. In addition, a measurement value divergence score Mhb corresponding to the device ID “BT002” at the same time is a value “0.09”. In addition, a variation divergence score Mha corresponding to the device ID “BT002” at the same time is a value “0.14”.

Accordingly, at the time “2012-03-13T10:31:20-09:00”, the value “0.13” of the measurement value divergence score Mhb corresponding to the device ID “BT001” is larger than the value “0.09” of the measurement value divergence score Mhb corresponding to the device ID “BT002”. Accordingly, it is understood that the measurement value Dy corresponding to the device ID “BT001” is further away from the average of the measurement values Dy of the plurality of devices 80 (“BT001” to “BT004”) corresponding to the same analysis unit ID rather than the measurement value Dy corresponding to the device ID “BT002”.

In addition, at the point of time “2012-03-13T10:31:20-09:00”, the value “0.20” of the variation divergence score Mha corresponding to the device ID “BT001” is larger than the value “0.14” of the variation divergence score Mha corresponding to the device ID “BT002”. Accordingly, it is understood that the variation CH corresponding to the device ID “BT001” is also further away from the average of the variations CH of the plurality of devices 80 corresponding to the same analysis unit ID rather than the variation CH corresponding to the device ID “BT002”.

In the example of the divergence score table 223 illustrated in FIG. 11, the value “0.75” of the variation divergence score Mha corresponding to the device ID “BT003” at the point of time “2012-03-13T10:31:30-09:00” is significantly different from other devices 80. However, the value “0.15” of the measurement value divergence score Mhb corresponding to the device ID “BT003” at the same time is not different from other devices 80. In this case, based on the fact that the divergence degree of the variation divergence score Mha is large, for example, the abnormality determination module 213 specifies the device ID “BT003” as a device 80x which has the abnormality sign. Further, the abnormality determination module 213 stores the information of the specified device 80x in the abnormal device table 224 which will be described later in FIG. 12.

As illustrated in FIG. 11, there is a case in which the variation CH is different from those of other device 80 even when the measurement value Dy is not different from those of other device 80. In such as case, since the abnormality sign does not appear in the measurement value Dy based on the measurement value Dy, it is difficult to specify the device ID “BT003”. In the embodiment, based on the variation CH, it is possible to specify the device 80 which has the abnormality sign even when the abnormality does not appear in the measurement value.

### Abnormal Device Table

FIG. 12 is a diagram illustrating an example of the abnormal device table 224 illustrated in FIG. 4. The abnormal device table 224 illustrated in FIG. 12 includes information of the device 80 which has the abnormality sign, the measurement value Dy and the variation CH which indicate the abnormality sign, a measurement value divergence score Mhb, and a variation divergence score Mha. The variation CH and the divergence score are the same as in the description with reference to FIGS. 7, 9, and 11. The abnormal device table 224 illustrated in FIG. 12 includes the information of abnormality corresponding to the device ID “BT003” at the time “2012-03-13T10:31:30-09:00”.

As described above, the abnormal device specifying program 210 according to the embodiment acquires the measurement values of the devices 80 for each of the respective ones of the plurality of devices 80 in which a predetermined item indicative of the information of the device 80 is identical. In addition, the abnormal device specifying program 210 calculates the variation CH, which indicates the difference between the acquired measurement value Dy and the estimated value Dp of the measurement value based on the past measurement values Dx of the device 80, for each of the plurality of devices 80. Further, the abnormal device specifying program 210 specifies the device 80 which has the variation CH that is different from those of other devices from among the plurality of devices 80.

As described above, the abnormal device specifying program 210 according to the embodiment compares the variation CH in the actual measurement value Dy for the estimated value Dp with those of other devices 80. When the variation CH, in which the change in the properties of the device 80 appears, is compared, it is possible to detect the change in the properties of the device 80, that is, the abnormality sign. Therefore, it is possible for the person in charge to prepare a countermeasure before a range which is affect by the abnormality of the device 80 becomes large.

In addition, according to the abnormal device specifying program 210, even when, for example, the measurement value Dy does not indicates an abnormality, it is possible to detect the abnormality sign at a point of time that the properties are changed based on the variation CH. In addition, even when, for example, the measurement value Dy is the same as those of the plurality of devices 80 in which each a predetermined item is identical, it is possible to specify the device 80, in which the way of variation in the measurement value Dy is different, based on the variation CH. Accordingly, it is possible to specify the device 80 which has the abnormality sign.

In addition, the abnormal device specifying program 210 according to the embodiment specifies a device 80, which the variation CH that indicates the change in behavior and that is different from those of other devices 80, between the plurality of devices 80 which have equivalent behaviors in a normal case. Therefore, it is possible to specify a device 80 which has a behavior that is different from those of other devices 80 without generating monitoring rules. Accordingly, in a state in which it is not easy to generate the monitoring rules for detecting the abnormality, it is possible to specify the device 80 which has the abnormality sign without generating the monitoring rules.

In addition, the abnormal device specifying program 210 according to the embodiment detects the abnormality sign of the device 80 by comparing the behaviors of the plurality of devices 80 in which the predetermined item is identical at a certain time. Accordingly, it is not desired to model the relationship between input information (the properties, the input, or the like) and output information (measurement value) for the device 80 at normal time. Since it is not desired to generate a model at normal time, it is possible to easily specify the device 80 which has the abnormality sign.

In addition, the abnormal device specifying program 210 according to the embodiment compares the variations CH with each other while limiting the plurality of devices 80 in which the predetermined item indicative of the pieces of information of the devices 80 is identical. It is possible to easily extract the plurality of devices 80, in which the predetermined item is identical, according to setting information or the like. Therefore, even when a plurality number of devices 80 are set to the monitoring targets, it is possible to easily detect the device 80 which has the abnormality sign.

In addition, for example, even when the item indicative of the information of the device 80, such as the properties (model or the like) or the input (the temperature or outside loads or the like), changes, it is possible to easily detect the device 80 which has the abnormality sign by extracting a plurality of devices 80 in which the item is identical. Therefore, in the embodiment, it is hardly affected by an environment or the like for the monitoring target device 80, and thus it is possible to further flexibly perform the process of specifying the device 80 which has the abnormality sign.

Subsequently, according to FIGS. 13 to 15, processes performed by the variation calculation module 211, the divergence score calculation module 212, and the abnormality determination module 213, which are described with reference to FIG. 6, will be described according to flowcharts.

### Variation Calculation Module

FIG. 13 is a flowchart illustrating the process performed by the variation calculation module 211 illustrated in FIG. 6. The variation calculation module 211 performs processes in steps S11 to S18 for every prescribed period. For example, in the embodiment, the variation calculation module 211 performs processes in steps S11 to S18 in units of 10 seconds. However, the embodiment is not limited to the units of 10 seconds. The monitoring operator sets a fixed time according to, for example, the emergency of abnormality detection.

In S11, the variation calculation module 211 performs the processes in steps S12 to S18 for every analysis unit ID. The variation calculation module 211 selects one analysis unit ID with reference to the device list table 220 illustrated in FIG. 5.

In S12, the variation calculation module 211 selects one device 80 from among a plurality of devices 80 corresponding to the selected analysis unit ID. In addition, the variation calculation module 211 refers to the measurement value table 221 illustrated in FIG. 7, and extract the newest measurement value Dy corresponding to the types of operation data, which is measured in the selected device 80. When a plurality of types of operation data are set to measurement targets, the variation calculation module 211 selects one operation data, and extracts the measurement value Dy.

In S13, the variation calculation module 211 further extracts past measurement values Dx of the same device 80 during a prescribed period with regard to the newest measurement value Dy which is extracted in step S12, and stores the measurement values Dx in an internal storage. The internal storage is, for example, the RAM 201 of the abnormal device specifying apparatus 10.

In S14, the variation calculation module 211 calculates the maximum likelihood value Dp of the newest measurement value Dy based on the past measurement values Dx which is extracted in step S13. The variation calculation module 211 calculates the maximum likelihood value Dp according to, for example, the weighted auto-regression analysis or the regression analysis described with reference to FIG. 8.

In S15, the variation calculation module 211 calculates the difference df (FIG. 8) between the newest measurement value, which is extracted in step S12, and the maximum likelihood value Dp of the measurement value which is calculated in step S14.

In S16, the variation calculation module 211 extracts the immediately before (the last) variation CH, and stores the extracted variation CH in the internal storage. The immediately before variation CH is the variation CH which is calculated according to the last step 17 of the flowchart of FIG. 13.

In S17, the variation calculation module 211 calculates the variation CH (hereinafter, also referred to as a variation point score) corresponding to the newest measurement value Dy based on the difference df, which is calculated in step S15, and the last variation CH which is extracted in step S16. The variation calculation module 211 stores the calculated variation CH in the variation table 222 which is described in FIG. 9. For example, the variation calculation module 211 calculates the variation CH in the newest measurement value according to Equation “s=a+(1−d)s′”. The value “s” in Equation indicates the variation CH in a calculation target, and the value “s′” indicates the immediate before (the last) variation CH. The value “a” in Equation indicates the difference df which is calculated in step S15. The value “d” in Equation indicates a forgetting coefficient.

According to above Equation, the variation calculation module 211 calculates the variation CH in the newest measurement value based on the past variation CH. That is, in above Equation, a value, which is acquired by applying a forgetting coefficient to the past variation CH, is added to the difference df, and the variation CH is calculated. Therefore, it is possible for the variation calculation module 211 to calculate the variation CH in the newest measurement value Dy to which the variation CH in the past measurement values Dx are reflected.

More specifically, for example, when a small variation CH continuously occurs for a long period, the variation CH increases based on the past variation CH. Therefore, for example, when variation continuously occurs for a long period even though the variation CH is a small amount, it is possible to detect an abnormality. As described above, when the variation CH, to which the past variation CH is reflected, is calculated, it is possible to specify the device 80 which has a finer abnormality sign.

In S18, the variation calculation module 211 determines whether or not the variation CH is completely calculated for all the devices 80 corresponding to the analysis unit ID and for the newest measurement value Dy of all the operation data of the device 80. When the variation CH is not completely calculated (NO in S18), the variation calculation module 211 performs the processes in step S12 to S17 on another device 80 or another operation data as a target. In contrast, when the variation CH is completely calculated (YES in S18), the variation calculation module 211 ends the process.

### Divergence Score Calculation Module

FIG. 14 is a flowchart illustrating a process performed by the divergence score calculation module 212 illustrated in FIG. 6. The divergence score calculation module 212 performs the processes in steps S21 to S25 for every prescribed period in the same manner as the flowchart of the variation calculation module 211 described in FIG. 13.

In S21, the divergence score calculation module 212 performs the processes in steps S22 to S25 for each analysis unit ID. The divergence score calculation module 212 selects one analysis unit ID with reference to the device list table 220 (FIG. 5).

In S22, the divergence score calculation module 212 selects one device 80 from among a plurality of devices 80 corresponding to the selected analysis unit ID. The divergence score calculation module 212 extracts the measurement value Dy and the variation CH (variation point score) of all types of operation data measured in the selected device 80.

More specifically, the divergence score calculation module 212 refers to the measurement value table 221 (FIG. 7), and extracts the newest measurement value Dy of the all types of operation data of the selected device 80. In addition, the divergence score calculation module 212 refers to the variation table 222 (FIG. 9), and extracts the newest variation CH of the all types of operation data of the selected device 80.

In S23, the divergence score calculation module 212 prepares the variation coordinates co1a and the measurement value coordinates co1b based on the newest variation CH and the measurement value Dy which are acquired in step S22. The divergence score calculation module 212 generates the variation coordinates co1a by plotting the variation CH of each of the plurality of operation data on a space in which the variation CH of each of the plurality of data is set to a coordinate axis. In addition, the divergence score calculation module 212 generates the measurement value coordinates co1b by plotting the measurement value Dy of each of the plurality of operation data on a space in which the measurement value Dy of each of the plurality of data is set to a coordinate axis.

In S24, the divergence score calculation module 212 determines whether or not the processes in steps S22 and S23 are completed for all the devices 80 corresponding to the analysis unit ID. While the processes are not completed (NO in S24), the divergence score calculation module 212 repeats the processes in steps S22 and S23 for another device 80.

Therefore, the divergence score calculation module 212 plots the variations CH of the respective devices on the plane in which the respective variations CH of the plurality of operation data are coordination axes. In addition, the divergence score calculation module 212 plots the measurement values Dy of the respective devices on the plane in which the respective measurement values Dy of the plurality of operation data are coordination axes.

In S25, when the processes in steps S22 and S23, in which all of the devices 80 corresponding to the analysis unit ID are targets, are completed (YES in S24), the divergence score calculation module 212 calculates the variation divergence score Mha and the measurement value divergence score Mhb.

More specifically, the divergence score calculation module 212 calculates the respective Mahalanobis distances of the devices 80 based on the variation coordinates co1a of the plurality of devices 80 corresponding to the selected analysis unit ID. Further, the divergence score calculation module 212 sets the Mahalanobis distances of the variations CH of the respective devices 80 to the variation divergence scores Mha of the respective devices 80.

In the same manner, the divergence score calculation module 212 calculates the Mahalanobis distances of the measurement values Dy of the respective devices 80 based on the measurement value coordinates co1b of the plurality of devices 80 corresponding to the selected analysis unit ID. Further, the divergence score calculation module 212 sets the Mahalanobis distances of the measurement values Dy of the respective devices 80 to the measurement value divergence scores Mhb of the device 80.

The Mahalanobis distances are described with reference to FIG. 10. The divergence score calculation module 212 stores the calculated variation divergence scores Mha and the measurement value divergence scores Mhb in the divergence score table 223 (FIG. 11).

### Abnormality Determination Module

FIG. 15 is a flowchart illustrating a process performed by the abnormality determination module 213 illustrated in FIG. 6. The abnormality determination module 213 performs the processes in steps S31 to S36 for every prescribed period in the same manner as the flowchart of the variation calculation module 211 illustrated in FIG. 13.

In S31, the abnormality determination module 213 performs processes in steps S32 to S36 for every analysis unit ID. The abnormality determination module 213 refers to the device list table 220 (FIG. 5), and selects one analysis unit ID.

In S32, the abnormality determination module 213 refers to the divergence score table 223 (FIG. 11), and acquires variation divergence scores Mha and the measurement value divergence scores Mhb of the plurality of devices 80 corresponding to the selected analysis unit ID at target time. Further, the abnormality determination module 213 generates two-dimensional coordinates co2 based on the variation divergence scores Mha and the measurement value divergence scores Mhb. More specifically, the abnormality determination module 213 generates a two-dimensional space in which an X axis is set to the variation divergence score Mha and a Y axis is set to measurement value divergence score Mhb. Further, the abnormality determination module 213 plots the variation divergence score Mha and the measurement value divergence score Mhb of each of the plurality of devices 80 corresponding to the selected analysis unit ID in the two-dimensional space.

In S33, the abnormality determination module 213 selects the two-dimensional coordinates co2 of one device 80 from the two-dimensional space. Further, the abnormality determination module 213 calculates a distance from an origin in the two-dimensional space of the two-dimensional coordinates co2 of the selected device 80.

In S34, the abnormality determination module 213 determines whether or not the distance from the origin, which is calculated in step S33, is equal to or larger than the threshold value. The threshold value is set based on, for example, the result of past abnormality determination or the like.

In S35, when the distance from the origin is equal to or larger than the threshold value (YES in S34), the abnormality determination module 213 determines that the variation CH of the selected device 80 is different from other devices 80 corresponding to the same analysis unit ID. That is, the abnormality determination module 213 specifies that the selected device 80 is the device 80 which has the abnormality sign. The abnormality determination module 213 stores the information of the specified device 80 in the abnormal device table 224 (FIG. 12).

As described above, the abnormality determination module 213 according to the embodiment specifies a device 80, which has the variation that is different from those of other devices 80, based on the variation divergence scores Mha and the measurement value divergence scores Mhb. That is, the abnormality determination module 213 specifies a device 80, in which the variations CH and the measurement values Dy are different from those of other devices 80. Therefore, it is possible for the abnormality determination module 213 to specify a device 80 which has the variation CH and the measurement value Dy that are comprehensively different from those of other devices 80. Therefore, it is possible to further securely specify the device 80 which has the abnormality sign. Meanwhile, the abnormality determination module 213 may specify two or more devices 80 as the device 80, which has the abnormality sign, from among the plurality of devices 80 corresponding to the same analysis unit ID.

Further, in S36, the abnormality determination module 213 determines whether or not the processes in step S33 to S35 are completed with regard to the two-dimensional coordinates cot of all the devices 80 which are generated in step S32. When the processes are not completed (NO in S36), the abnormality determination module 213 selects the two-dimensional coordinates of another device 80, and performs the processes in steps S33 to S35. In contrast, when the processes are completed (YES in S36), the abnormality determination module 213 ends the process.

### Second Embodiment

The first embodiment illustrates a case in which the abnormality determination module 213 determines the presence or non-presence of the abnormality sign based on the variation divergence scores Mha and the measurement value divergence scores Mhb. However, the embodiment is not limited to the example.

In a second embodiment, the abnormality determination module 213 specifies a device 80 which has the abnormality sign based on only the variation divergence scores Mha. That is, the abnormal device specifying program 210 compares only the variations CH between the plurality of devices 80 corresponding to the same analysis unit, thereby specifying a device 80 in which the variation CH is different from those of other devices 80.

A hardware configuration diagram (FIG. 4) of an abnormal device specifying apparatus 10 according to the second embodiment is the same as in the first embodiment. The software block diagram of the abnormal device specifying apparatus 10 according to the second embodiment is the same as in FIG. 6 according to the first embodiment.

However, in the second embodiment, the divergence score calculation module 212 illustrated in FIG. 6 does not input the measurement values Dy (300 in FIG. 6). That is, the divergence score calculation module 212 calculates only the variation divergence scores Mha without calculating the measurement value divergence scores Mhb. Accordingly, the divergence score calculation module 212 according to the second embodiment does not calculate the measurement value divergence scores Mhb in step S25 in the flowchart of FIG. 14.

Further, the abnormality determination module 213 specifies a device 80, which has the variation CH that is different from those of other devices 80, from among the devices 80 corresponding to the same analysis unit ID based on the variation divergence scores Mha of the plurality of devices 80. A process performed by the abnormality determination module 213 according to the second embodiment is the same as in the first embodiment excepting for steps S32 to S34 in a flowchart of FIG. 15.

The abnormality determination module 213 determines whether or not a predetermined variation divergence score Mha is equal to or larger than the threshold value instead of performing the processes in steps S32 to S34 in the flowchart of FIG. 15. When the variation divergence score Mha is equal to or larger than the threshold value, the abnormality determination module 213 determines that the variation CH is different from the variations CH of other devices 80 corresponding to the same analysis unit ID (S35 in FIG. 15). That is, the abnormality determination module 213 specifies that a selected device 80 is the device 80 which has the abnormality sign.

The abnormality determination module 213 determines whether or not a process of comparing with the threshold value is completed for the variation divergence scores Mha of all devices 80 (S36 in FIG. 15). When the process is completed, the abnormality determination module 213 ends the process.

As described above, it is possible for the abnormal device specifying program 210 according to the second embodiment to specify the device 80, which has the variation CH that is different from those of other devices 80, based on the variation divergence scores Mha. That is, it is possible for the abnormal device specifying program 210 to specify the device 80, which has the variation CH that is different from those of the plurality of devices 80, as the device 80 which has the abnormality sign based on the variation CH. In addition, it is possible to specify the device 80 which has the abnormality sign even when the measurement value Dy does not indicates a clear abnormality based on the comparison performed on the variation CH.

### Another Embodiment

First, the second embodiment illustrates the example in which the Mahalanobis distance (variation divergence score Mha) is calculated based on the correlation of the variations CH in two types of measurement values (the temperature and the voltage), and the Mahalanobis distance is compared with the threshold value.

In another embodiment, the divergence score calculation module 212 may calculate the Mahalanobis distance based on the correlation between the measurement value Dy and the variation CH in the measurement value Dy, and may compare the Mahalanobis distance with the threshold value, thereby specifying a device 80 which has an abnormality sign. Therefore, it is possible to specify a device 80 which is different from other devices 80 using distribution based on the correlation between the variation CH and the measurement value between the plurality of devices 80.

According to a device 80, there is a case in which an abnormality sign appears in the distribution based on the correlation between the variation CH and the measurement value Dy. For example, there is a case in which a state, in which the variation CH is different from those of other devices 80 even though the measurement value Dy is not different from those of other devices 80, corresponds to the abnormality sign. In addition, there is a case in which a state, in which the measurement value Dy is different from those of other devices 80 even though the variation CH is not different from those of other devices 80, corresponds to the abnormality sign.

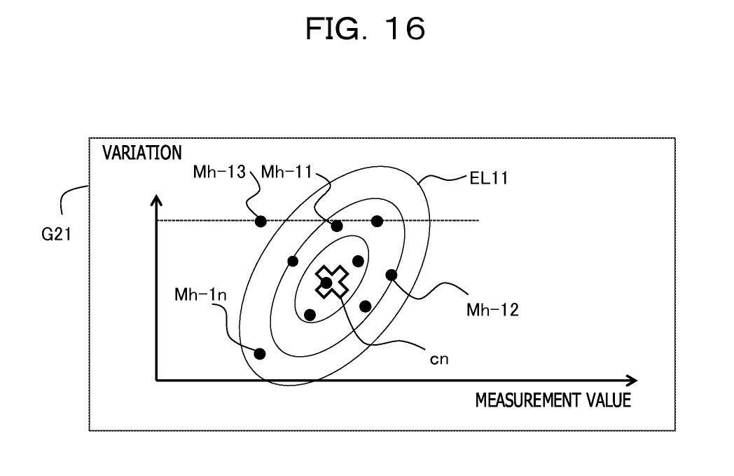

FIG. 16 is a graph G21 illustrating a Mahalanobis distances Mh-11 to Mh-1n based on the correlation between the measurement values of devices 80-11 to 80-1n and the variation CH in the measurement values. In the graph G21, a vertical axis indicates the variation CH and the horizontal axis indicates the measurement value. A point cn in the graph G21 indicates the center (average) of the measurement values Dy and the variations CH of the devices 80-11 to 80-1n. In addition, an ellipse EL11 indicates a position indicative of the same Mahalanobis distance. A method of calculating Mahalanobis distances Mh-11 to Mh-1n based on the correlation between the measurement values Dy and the variations CH is the same as the method of calculating the Mahalanobis distances of the variations CH described with reference to FIG. 10.

The abnormality determination module 213 specifies, for example, a device 80 in which the Mahalanobis distances Mh-11 to Mh-1n between the measurement values Dy and the variations CH are larger than the threshold value indicated by the ellipse EL11 of the graph, as a device 80 in which the variation CH is different. That is, the abnormality determination module 213 specifies a device 80, in which a distribution based on the correlation between the measurement value Dy and the variation CH is different from those of other devices 80, as the device 80 which has the abnormality sign from among the plurality of devices 80.

In an example of FIG. 16, the variation CH and the measurement value Dy of the device 80-13 are not singly deviated from the distribution of other devices 80-11 to 80-12 and 80-14 to 80-1n. However, the Mahalanobis distance Mh-13 based on the correlation between the variation CH and the measurement value Dy of the device 80-13 is larger than the threshold value indicated by an ellipse EL11. That is, the distribution based on the correlation between the variation CH and the measurement value Dy of the device 80-13 is different from the distributions of other devices 80-11 to 80-12 and 80-14 to 80-1n. Accordingly, the abnormality determination module 213 specifies the device 80-13 as the device 80 which has the abnormality sign.

As described above, when the distribution based on the correlation between the variation CH and the measurement value Dy is compared with those of other devices 80 between the plurality of devices 80, it is possible to specify the device 80 which has a finer abnormality sign.

In addition, in the example of FIG. 5, the abnormal device specifying program 210 according to the embodiment extracts a plurality of devices 80, in which the item “model” which is relevant to the properties and the item “installation place” which is relevant to the input are identical, as the same analysis unit. However, the embodiment is not limited to the example. The abnormal device specifying program 210 may extract, for example, a plurality of devices 80, in which only the item which is relevant to the input “installation place” is identical, as the same analysis unit.

Therefore, it is possible for the abnormal device specifying program 210 to specify a device 80, in which the variation CH is different, between the plurality of devices 80 in which the item which is relevant to the input to the device 80 is identical. Therefore, for example, it is possible to compare the variations CH between a plurality of devices 80 in which the inputs (outside temperature or the like) to the devices 80 from the outside are identical. Therefore, for example, even when the outside temperature or the like change, it is possible to specify a device 80 in which the variation CH is different between the plurality of devices 80 in which outside temperatures are identical.

In addition, in the example of FIG. 8, the variation calculation module 211 according to the embodiment calculates the maximum likelihood value Dp based on the past measurement values Dx, and calculates the variation CH which indicates the difference df between the maximum likelihood value Dp and the measurement value Dy. However, the embodiment is not limited to the example. The variation calculation module 211 may calculate an average value based on the past measurement values Dx, and may calculate the variation CH which indicates the difference df between the average value and the measurement value Dy.

For example, when the variation in the past measurement values Dx according to time series is small, it is valid to set the average value based on the past measurement values Dx to an estimated value. Accordingly, the variation calculation module 211 may calculate the variation CH based on the difference df between the average value based on the past measurement values Dx and the measurement value Dy.

In addition, in the flowchart of FIG. 15, the abnormality determination module 213 plots the variation divergence score Mha and the measurement value divergence score Mhb on the two-dimensional coordinates, and compares the distance between the origin and the two-dimensional coordinates with the threshold value (S32 to S34 in FIG. 15).

However, the embodiment is not limited to the example. For example, the abnormality determination module 213 may specify a device 80, in which both the measurement value divergence score Mhb and the variation divergence score Mha are equal to or larger than a predetermined threshold value, as a device 80 which has an abnormality sign. In addition, the abnormality determination module 213 may specify a device 80, in which any one of the measurement value divergence score Mhb and the variation divergence score Mha is equal to or larger than the predetermined threshold value, as a device 80 which has an abnormality sign.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A specifying method executed by a computer, the specifying method comprising:
acquiring, every specific time interval, a measurement value of a specific property from each of a plurality of devices which have the specific property;
calculating a variation between the measurement value for each of the plurality of devices and an estimated value based on a plurality of past measurement values which are acquired from the plurality of devices prior to the measurement value; and
specifying at least one device, which expresses a different behavior from other devices, from among the plurality of devices based on a set of variations including the variation regarding the plurality of devices.

2. The specifying method according to claim 1, wherein the plurality of devices include one or more identical items from among a plurality of items which include an item relevant to a plurality of properties including the specific property and an item relevant to input to the plurality of respective devices.

3. The specifying method according to claim 1, wherein the estimated value is a maximum likelihood value of the plurality of past measurement values.

4. The specifying method according to claim 1, wherein the at least one device is a device which has the variation and the measurement value that are different from those of other devices by specific values or more.

5. The specifying method according to claim 1, wherein the at least one device is specified based on a distribution based on a correlation between the variation and the measurement value.

6. The specifying method according to claim 1, wherein
the measurement value is acquired for each of a plurality of types of specific properties,
the variation is calculated for each of the plurality of types of measurement values, and
the at least one device is specified based on a distribution of a correlation of the variation for each of the plurality of types of measurement values.

7. The specifying method according to claim 1, wherein the at least one device is a device in which a distance of the variation from a reference value indicative of an average of the variations of the plurality of respective devices is larger than a specific value.

8. The specifying method according to claim 1, wherein the at least one device is further specified based on a past difference relevant to each of the plurality of past measurement values.

9. The specifying method according to claim 8, wherein the at least one device is specified based on a value acquired by adding the past variation, to which a forgetting coefficient is applied, to the variation.

10. A non-transitory storage medium storing a specifying program which causes a computer to execute a process, the process comprising:
acquiring, every specific time interval, a measurement value of a specific property from each of a plurality of devices which have the specific property;
calculating a variation between the measurement value for each of the plurality of devices and an estimated value based on a plurality of past measurement values which are acquired from the plurality of devices prior to the measurement value; and
specifying at least one device, which expresses a different behavior from other devices, from among the plurality of devices based on a set of variations including the variation regarding the plurality of devices.

11. A specifying apparatus comprising:
a memory; and
a processor coupled to the memory and configured to:
acquire, every specific time interval, a measurement value of a specific property from each of a plurality of devices which have the specific property,
calculate a variation between the measurement value for each of the plurality of devices and an estimated value based on a plurality of past measurement values which are acquired from the plurality of devices prior to the measurement value, and
specify at least one device, which expresses a different behavior from other devices, from among the plurality of devices based on a set of variations including the variation regarding the plurality of devices.

12. The specifying apparatus according to claim 11, wherein the plurality of devices include one or more identical items from among a plurality of items which include an item relevant to a plurality of properties including the specific property and an item relevant to input to the plurality of respective devices.

13. The specifying apparatus according to claim 11, wherein the estimated value is a maximum likelihood value of the plurality of past measurement values.

14. The specifying apparatus according to claim 11, wherein the at least one device is a device which has the variation and the measurement value that are different from those of other devices by specific values or more.

15. The specifying apparatus according to claim 11, wherein the at least one device is specified based on a distribution based on a correlation between the variation and the measurement value.

16. The specifying apparatus according to claim 11, wherein
the measurement value is acquired for each of a plurality of types of specific properties,
the variation is calculated for each of the plurality of types of measurement values, and
the at least one device is specified based on a distribution of a correlation of the variation for each of the plurality of types of measurement values.

17. The specifying apparatus according to claim 11, wherein the at least one device is a device in which a distance of the variation from a reference value indicative of an average of the variations of the plurality of respective devices is larger than a specific value.

18. The specifying apparatus according to claim 11, wherein the at least one device is further specified based on a past difference relevant to each of the plurality of past measurement values.

19. The specifying apparatus according to claim 18, wherein the at least one device is specified based on a value acquired by adding the past variation, to which a forgetting coefficient is applied, to the variation.
